(19) United States
(12) Patent Application Publication
(10) Pub. No.: US 2008/0159510 A1
(43) Pub. Date: Jul. 3, 2008

(54) Method And System For Supplying Information To Participants In A Telephone Conversation

(75) Inventors: Anne Julien, Noisy Le Roi (FR); Emmanuelle Bernard, Paris (FR); Sebastien Granier, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: France Telecom, Paris (FR)

(21) Appl. No.: 11/816,845

(22) PCT Filed: Feb. 16, 2006
(86) PCT No.: PCT/FR06/50144

§ 371 Date: Mar. 21, 2008

(30) Foreign Application Priority Data
Feb. 22, 2005 (FR) 0501806

(51) Int. Cl. H04M 3/56

(52) U.S. Cl. 379/202.01

(57) ABSTRACT

A method of supplying information to participants in a telephone conference call carried out using a telecommunication network, a plurality of terminals, and a conference server. A data transmission link is established between at least two terminals and a data server that accesses the network, the data transmission link being independent of the communication link used for the transmission of voice streams established between the relevant terminal and the conference server. The conference server analyzes the streams received from the terminals during the conference to determine at least one pre-defined event relating to the progress of the conference and generates event identification data. The data server analyzes the identification data, generates information relating to the identified events, and transmits the information to the terminals for which a data transmission link has been established, via the data transmission link.

The invention relates to a method and system for supplying information to the participants in a telephone conference.

Telephone conference, group telephone conversation or audioconference type applications exist both in the Internet field, in which the voice stream is transmitted using techniques termed voice over IP (VoIP), and in the field of conventional telephony in which the voice stream is transmitted by cellular network of GSM/GPRS (Global System for Mobile communication/General Packet Radio Service) type, or else by fixed telephone network of PSTN (Public Switch Telephone Network) or ISDN (Integrated System Digital Network) type.

During an audioconference involving numerous participants, it may be useful to benefit during the conduct of the conference, for example by display or by any other mode of signaling, from information about the identity of the active speaker or about events such as the arrival and/or departure of a participant. Displaying information about the identity of the active speaker allows in particular unambiguous identification of the active speaker and thus affords listening comfort to the participants.

Among the existing audioconference applications which make it possible to dynamically inform participants about the active speaker are the audioconference solutions, which use a coupling between two separate terminals: on the one hand a telephone terminal in charge of the voice stream, and on the other hand a terminal of personal computer type for handling the receipt and display of the data relating to the conferences in progress, the identification of the participants in the various conferences and the identification of the active speaker for each of these conferences.

This type of technique has the drawback of requiring two different terminals and a coupling between these two terminals, to ensure in a simultaneous and synchronized manner the transmission, on the one hand of the participants identification data, and on the other hand the transmission of the voice streams.

Other known solutions implement a telephone conversation service of Push-To-Talk over Cellular (PoC) type standardized by the OMA (Open Mobile Alliance) organization on the basis of standard GSM/GPRS terminals. In such a service, operating according to the walkie-talkie principle, a participant must signal himself before speaking, by dispatching a speech request petition to a telephone connection server allowing the management of the communication session and audio streams. In the course of the conversation, the right of speech is distributed to the participants by the server as a function of the petitions received, a single participant having the possibility of speaking at a given moment. In such an application, the information relating to the identity of the active speaker is determined on the basis of the right of speech allocated. In the packet mode implementation of the PoC service such as standardized by the OMA, the frames of the voice streams are transmitted according to the RTP (Real Time Protocol) protocol, while the control data for communicating the voice streams as well as the information relating to the identity of the speaker are transmitted according to the associated RTCP (Real Time Control Protocol) protocol. However this type of service is applicable only to packet mode communications, the circuit mode implementation of the PoC service not making it possible to provide the conference participants with information about the active speaker. Consequently the field of application of the PoC service as regards the provision of information about the conference to the participants is restricted.

Patent document U.S. Pat. No. 6,072,780 A proposes a system for supplying information to the conference participants about events such as a participant's arrival at the conference. However, this system is not suited to the implementation of the service by means of a single terminal for each participant in the conference. It is relatively complex since it assumes that one of the participants possesses a personal computer for the implementation of a dedicated communication with the switch of the conference telephone bridge so as to drive this switch and to receive information in return. Finally, this system does not make it possible to dispatch information relating to the active speaker.

The invention is therefore aimed at providing a system for supplying information to the participants in a telephone conference about the conduct of the latter, in particular as regards the identity of the active speaker, this system being adapted in particular to the use of a single terminal for each participant in the conference, and to circuit mode communications in general.

With this aim, the subject of the invention is, according to a first aspect, a method for supplying information to the participants in a telephone conference about the conduct of the conference, the conference being implemented by means of a plurality of terminals accessing a telecommunication network, a communication link being established between each terminal and a conference server for the transmission of at least one conference data stream, the method being noteworthy in that it comprises the following steps in the course of which:
a data transmission link is established between at least one of the terminals and a data server accessing said telecommunication network, the data transmission link being independent of the communication link established for the terminal considered;
the conference server analyzes the conference data streams received from the terminals in the course of the conference, determines at least one predefined event relating to the conduct of the conference, generates event identification data for each event determined, and transfers the identification data to the data server;
the data server analyzes the event identification data, generates event information relating to the identified events, and transmits the event information, via at least one data transmission link, destined for at least one of said terminals for which a data transmission link has been established.

With such a method, the participants in a telephone conference have available a real-time information service on the conduct of the conference. By virtue of the establishment of a separate data link independent of the conventional communication link, a conventional telephone terminal, on condition it is suitable for the simultaneous establishment of both these types of links, accesses this information service. This is the case for example with the mobile telephone terminals termed third generation (3G-UMTS) or else 2.5 generation (GPRS) of class A.

Moreover, the simultaneous presence of the aforesaid two separate and independent links, one handling the voice streams (communication link), and the other handling the information data streams (data transmission link) permits the use of the type of connection termed circuit mode for the communication link, independently of the type of connection used for the data transmission link. In this situation, the quality of voice transmission inherent in the circuit mode is available, while benefiting from the functionality afforded by the participant information service implemented by a link established according to the packet mode.

Additionally, the information service according to the invention is also compatible with telephone terminals which do not allow the establishment of a second link intended for the transmission of data. In this case, these terminals remain operational in a context where the invention is implemented, but only as regards the transport of voice. Consequently, the field of application of the method according to the invention is very vast.

According to a characteristic of the invention, the data transmission link established for a given terminal is established following the detection by the conference server of the establishment of the communication link with this terminal.

In this way, the data transmission link can be established very rapidly after a participant has rejoined the conference by establishment of the communication link for the transmission of the conference data streams.

According to another characteristic of the invention, the data transmission link established for a given terminal is suited to the receipt by the terminal considered of a data stream simultaneously with the receipt of the conference data streams. These conference data streams comprise voice streams, and depending on the case, other streams, for example streams for controlling the voice streams.

In this way, setting up the data transmission link does not disturb the voice communication established by the communication link for the transmission of the conference data streams. The mobile telephone terminals termed third generation in particular make it possible to simultaneously establish a voice circuit mode communication session and a session for transmitting data in packet mode.

According to another characteristic of the invention, each recipient terminal of the event information processes this information so as to generate and display on a screen fitted to this terminal information relating to the event considered. The displaying of the information is particularly ergonomic and does not cause any disturbance to the user of the terminal as regards the conduct of the telephone conference.

According to another characteristic of the invention, the information displayed on the screen of each recipient terminal comprises information about the identity of the presumed user or users of the terminal or terminals involved in the event considered.

The method according to the invention thus makes it possible to associate with events detected by the conference server, information about the presumed user of each terminal involved in the event considered. The known conference servers already provide, on the basis of standard telephones, audible indications on the events of type “arrival or departure of participants”, but this information does not comprise any information about the identity of the participants involved in the event. The invention, conversely, allows a user of a suitable terminal (3G for example) to receive clear and explicit information about the detected events.

According to another characteristic of the invention, the events determined by the conference server are included in the set consisting of: “a participant enters the conference”, “a participant exits the conference”, “identification of a participant as new active speaker”, “a participant's turn to speak”, “a participant asks to speak”.

The method according to the invention consequently makes it possible to inform the participants in the conference on all sorts of events, in particular on events detectable by the conference server on the basis of the conference data streams.

Furthermore, by making it possible to combine the detection of the aforesaid events with the generation of information relating to the identity of the user or users involved in an event considered, the method according to the invention provides a service of dynamically identifying the active speakers.

According to an embodiment, the data server dispatches a message destined for at least one of said terminals for which a data transmission link has been established so as to trigger the establishment of the data transmission link for the terminal considered and the transmission in the course of the conference of said event information via said established data transmission link.

According to a particular embodiment, when one of the terminals is a mobile telephone terminal, the data server dispatches to this terminal, following the establishment for this terminal of the communication link, a message of short message type so as to trigger the establishment of the data transmission link for said terminal considered as well as the running in this terminal of a piece of software for executing the operations consisting in:
receiving said event information via said data transmission link,
processing said event information received so as to generate information to be displayed, and
controlling the display by a screen fitted to the terminal considered of said information to be displayed.

The invention thus requires no specific action on the part of the user or prior modification of the conference participant's terminal, since the software means necessary for processing the event information can be triggered remotely, or indeed downloaded, in an automatic manner, without intervention by the user of the terminal.

According to another aspect, the invention is aimed at a data server used for the implementation of a method according to the invention, this server comprising:
means for establishing a data transmission link with at least one of the terminals, said data transmission link being independent of the communication link established for the terminal considered;
means for receiving from said conference server event identification data relating to the conduct of the conference;
means for analyzing said event identification data and generating event information relating to the identified events; and
means for transmitting said event information, via at least one said data transmission link, destined for at least one of said terminals for which a data transmission link has been established.

According to yet another aspect, the subject of the invention is a conference server used for the implementation of a method according to the invention, comprising:
means for analyzing the conference data streams received from the terminals in the course of the conference, and determining at least one predefined event relating to the conduct of the conference;
means for generating event identification data for each event determined; and
means for transferring said identification data to said data server.

The advantages stated above for the method according to the invention are also valid for this data server and this conference server.

Other aims, characteristics and advantages of the invention will appear through the description which follows, given merely by way of nonlimiting example, and offered with reference to the appended drawings in which:

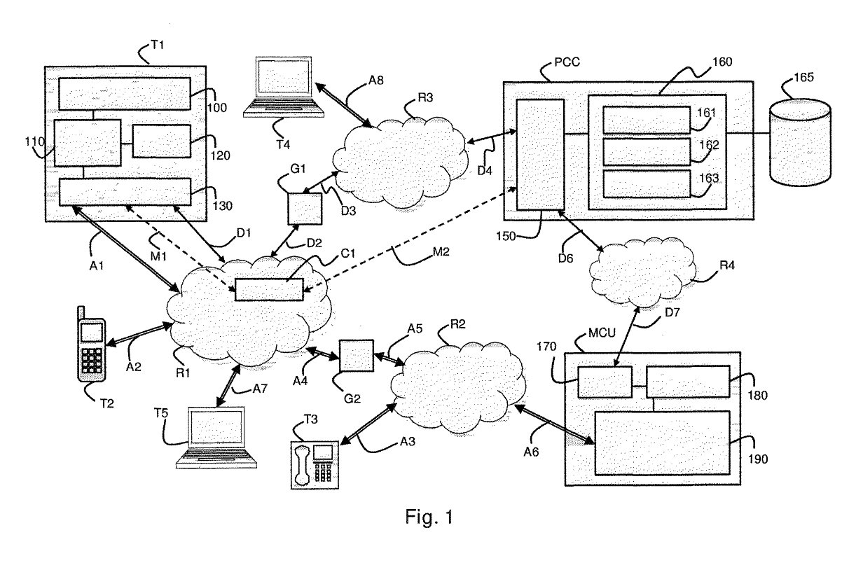

FIG. 1 schematically represents the architecture of a telephone conference system in which the invention can be implemented,

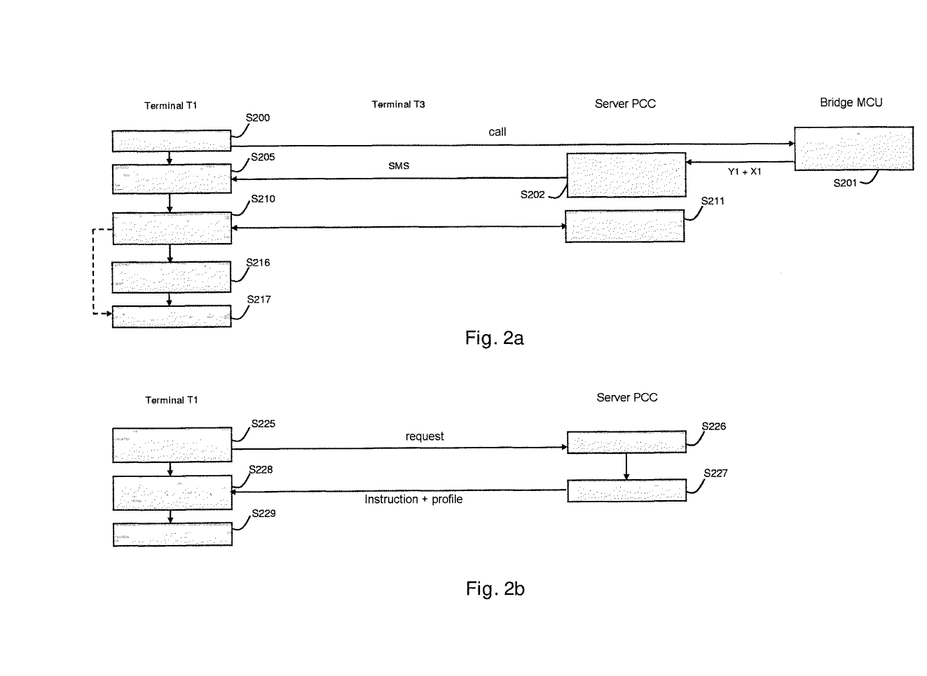

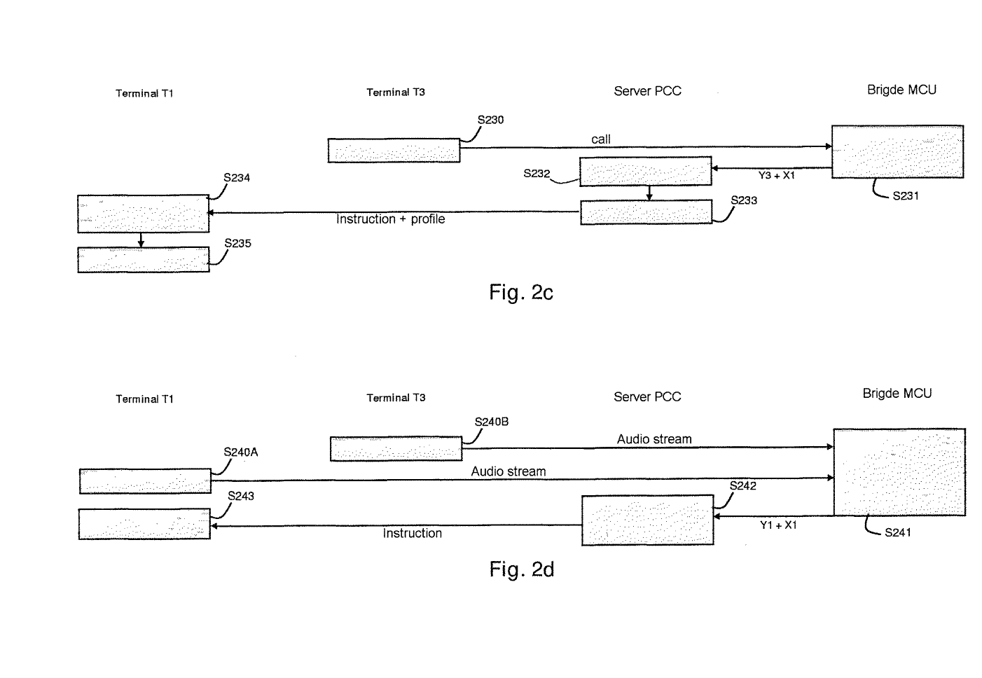

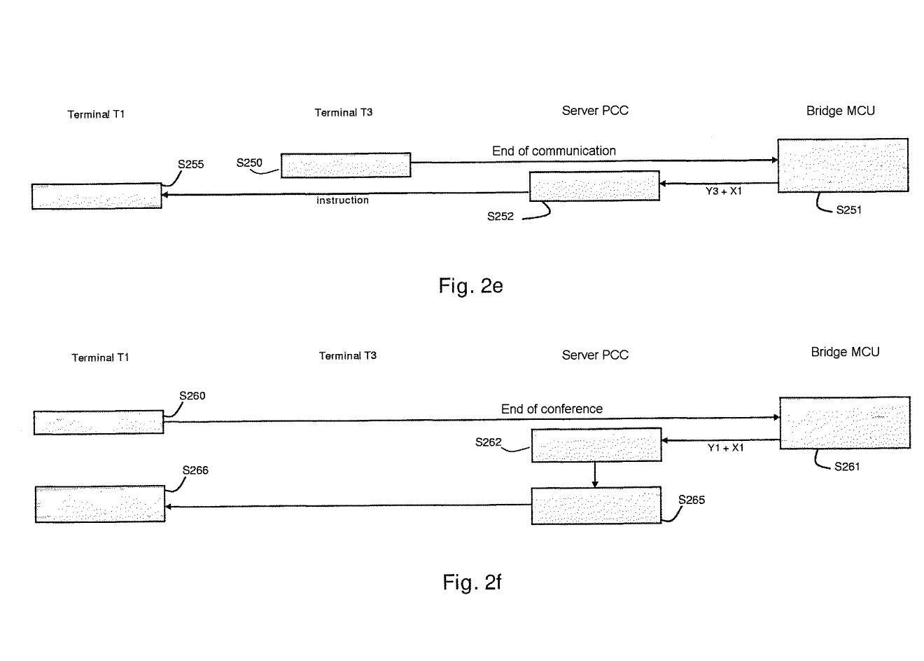

FIGS. 2a to 2f illustrate in a schematic manner various phases of the method according to the invention as well as the data exchanges between the entities relevant to these phases.

FIG. 1 schematically represents the architecture of a telephone conference system. The system represented is hinged around various communication networks which are:
a mobile telephone network R1, for example of GSM (Global System for Mobile communication), GPRS (General Packet Radio Service), UMTS (Universal Mobile Telecommunication System) type,
a fixed telephone network R2, for example of PSTN or ISDN type,
the Internet network R3,
a private network R4, for example of Ethernet type.

The network R1 comprises an SMS (Short Message Service) center C1 for handling and temporary storage of the messages of SMS type via the network R1. The telephone network R1 is interconnected with the Internet network R3 via a gateway G1 allowing the users of the telephone network R1 to access the Internet network R3. The telephone networks R1 and R2 are also interconnected via a gateway G2.

The system furthermore comprises five terminals T1 to T5. In this exemplary embodiment, the terminal T1 is a mobile telephone termed third generation (3G terminal) designed to access a network of UMTS type. The terminal T2 is a second-generation mobile telephone (2G or 2.5G terminal) designed to access a network of GPRS type, while the terminal T3 is a first-generation analog telephone (1G terminal). A fourth terminal T4, of personal computer type, is linked up to the Internet network R3. It can access applications of audioconference type by using VoIP techniques. The terminal T5, of personal computer type, for its part accesses the network R1 in circuit mode, for example by means of a suitable PCMCIA card which is integrated within this terminal. Each terminal uses an appropriate codec (coder/decoder) for sending and receiving voice streams, this codec being dependent on the terminal and suited to the network which this terminal accesses. For example, for a third-generation cellular network, an AMR (“Adaptive Multi Rate”) codec is used. For a second-generation cellular network, an EMR (“Enhanced Full Rate Speech”) codec is used. While within a PSTN/ISDN network, a codec compatible with the G711 standard (component of the H320 radio standard, established by the ITU-T, International Telecommunications Union) is generally used.

It is assumed, in the example described here, that the users of the telecommunication terminals T1 to T5 wish to participate in a group telephone conversation, called “telephone conference” in the context of the invention. The telephone connection between the terminals is performed by means of a conference server MCU, called here an audioconference bridge, intended to receive the voice stream of each of the telecommunication terminals T1 to T5 (or at least of these terminals) and to retransmit it to the other telecommunication terminals (or to at least some of the other terminals). A user wishing to participate in the conference establishes by means of his terminal a communication link with the audioconference bridge MCU for sending and receiving voice streams.

The channels for transmitting voice streams A1 to A8, tied to an audioconference established between the terminals T1 to T5, are represented in FIG. 1 by double arrows. These voice streams A1 to A8 are generally first mixed network by network (for example within the network R1 and independently within the network R2). The various mixed streams thus obtained are thereafter transmitted via network interconnection gateways to the audioconference bridge MCU linked up to one of the networks, here the network R2.

The system represented in FIG. 1 also comprises a data processing device PCC, of data server type, communicating with the audioconference bridge MCU via the private network R4 and the data transmission channels D6 to D7.

The data server PCC comprises a communication interface 150 allowing the server to access the private network R4 (data transmission channel D6), the Internet network R3 (data transmission channel D4), and to dispatch SMS messages to the telecommunication terminals (data transmission channel M2).

The data server PCC can communicate with the terminal T1, on the one hand via a data transmission channel D1 to D4 represented as a simple continuous line and on the other hand via a channel for transmitting messages M1 (of SMTP, Simple Mail Transfer Protocol, type for example), M2 of SMS type represented dashed. The SMS transmission is performed for the terminal T1 either in circuit mode, or in packet mode.

The data server PCC furthermore comprises data processing means 160, of calculation processor type, accessing a database 165. The data processing means 160 themselves comprise software modules 161 to 163 which are:
a software interface 163 for processing the data exchanged with the audioconference bridge MCU,
a software interface 161 for processing the data exchanged with the terminals T1 to T5 during an audioconference,
a data processing software engine 162 for command and coordination between the interfaces 161 and 163.

The database 165 is designed to record in the form of tables a set of data among which are:
a table of the subscribers to the audioconference participants information service comprising, for each subscriber identifier, subscriber identification data (for example name, password, telephone number, the type of terminal used, the list of the profiles recorded by the user, etc.),
a table of profiles of the subscribers comprising, for each profile identifier, the associated data of the profile (for example name, forename, company, function in the company, photograph of the subscriber, etc.),
a table of the conferences in progress comprising, for each conference identifier, the list of the identifiers of the participants in this conference,
a table of the participants comprising, for each participant identifier, a subscriber identifier, a profile identifier and a conference identifier.

These various tables are intended to be completed and updated during the execution of the method according to the invention, or possibly outside of this execution, for example when the subscribers register with the participants identification service.

The table of subscribers is completed in tandem with the registrations to the service. The table of subscriber profiles can be completed at any moment, including during an audioconference. With each subscriber can thus be associated one or more subscriber profiles. For example a subscriber will have on the one hand a profile termed “professional” indicating the company to which he belongs and his function in the company and on the other hand a profile termed “private” indicating his name, forename, surname, personal address. In each profile are recorded both alphanumeric data and multimedia data integrating images, moving or fixed, or sound sequences. Preferably a photograph of the subscriber is inserted into the data of the profile.

The table of conferences is completed and modified during the conduct of the conferences. The same holds for the table of participants. A participant corresponds to a subscriber, participating in a given conference with a given profile. A participant is characterized therefore by a subscriber identifier, a conference identifier and a subscriber profile identifier.

Returning to FIG. 1, the audioconference bridge MCU comprises a device 190 for processing the voice streams allowing the bridge MCU to process (typically by mixing) the various voice streams received from each of the telecommunication terminals T1, T2, T3 before retransmitting them to all or some of the telecommunication terminals. This device is capable of detecting the connection or the breakage of connection of a terminal. It also comprises a module for detecting the voice activity of the conference. This detection consists in particular in determining the sound level of each of the voice streams received. Such modules are known and customarily used to detect silence phases in conversation so as to allow a reduction in the amount of data to be retransmitted to the various terminals, or to detect the streams having the highest sound level so as to mix only those streams. Such a module is used to detect the sound level of each voice stream. In the context of the invention, it makes it possible to detect the speaking of the participants, in particular to determine which voice stream has the highest sound level. It is agreed that this stream corresponds to the stream of the active speaker. The presumed user of the terminal from which this stream originates is thus identified as being the active speaker. In the particular case where several conference participants are speaking simultaneously, it is therefore the one who speaks loudest that will be detected as being the active speaker.

The audioconference bridge MCU also comprises a communication interface 170 allowing access to the network R4 and a software interface 180 for processing the data exchanged with the data server PCC. The software interface 180 of the audioconference bridge MCU is complementary to the software interface 163 of the data server PCC. These interfaces 180 and 163 communicate between one another, for example through a communication channel D6-D7 established by means of a communication interface of IP (Internet Protocol) socket type, each interface associated with a network address (an IP address in this instance) and with a communication port identifier. This type of communication channel allows the establishment of a communication link in point-to-point mode between the data server PCC and the audioconference bridge MCU. This link is preferably dedicated to the implementation of the participants information service, that is to say reserved for the exchanging, between the terminal and the server PCC, of data allowing this implementation. The format of the data exchanged is for example the XML format, any other suitable format also being envisageable.

The audioconference bridge MCU and the data server PCC communicate in client/server mode, and any other communication link variant compatible with this operating mode is envisageable. It is thus possible to envisage a communication by messages, by remote function calls (RPC, Remote Procedure Call), by middleware, etc. Furthermore the network R4 can be a private or public (Internet) network, a virtual network, etc.

The audioconference bridge MCU dispatches to the data server PCC, by means of the software interface 180 and via the communication channel D6-D7, information relating to the following events, detected by the device 190 for processing the conference streams and/or the voice activity detection module:
the arrival of a first participant in an audioconference, that is to say the start of an audioconference,
the arrival of a new participant in a current audioconference,
the departure of a participant from an audioconference,
a change of active speaker, that is to say the identification of a participant as new active speaker,
a participant taking a turn to speak,
a participant requesting to speak (in PoC applications).

Each of these events is detectable by the audioconference bridge MCU on the basis of the conference data streams. According to the telephone conference application considered, this detection is done on the basis of the voice streams, on the basis of the requests to speak that are received (case of a telephone connection system in PoC applications) or on the basis of the streams for controlling transmission of voice streams. Following the detection by the audioconference bridge MCU of one of these events, the software module 180 triggers a dispatch of event identification data. Each dispatch of data to the data server PCC preferably comprises a code identifying the detected event, an identifier of the terminal from which the event originates and an identifier of the conference in progress. The identifier of the terminal is advantageously its telephone number. Specifically, this allows on the one hand simple identification of the terminals and on the other hand the use of this telephone number by the data server PCC to communicate with the terminal in question.

The telephone terminal T1, termed 3G terminal, comprises communication means 130 allowing it to establish a telephone communication link in circuit mode for transmitting the conference data streams and to establish a channel for communicating data in packet mode with the data server PCC, so as to allow the simultaneous and independent receipt of data and voice streams. By way of example, the terminal T1 can be a class A telephone terminal of 2.5G type or a terminal of 3G type. Such terminals, defined by the 3GPP organization (Third Generation Partnership Project, http://www.3gpp.org), actually make it possible to open a circuit mode communication session for receiving and sending voice streams and simultaneously a packet mode communication session for dispatching or receiving data streams. For example, a 2.5G mobile of class A can simultaneously access GSM services in circuit mode and GPRS services in packet mode.

The telecommunication terminal T1 furthermore comprises a display screen 100 in the form for example of a liquid crystal screen, a data memory 120, for example a memory of RAM type, a microprocessor 110 for data processing and program execution. In a preferred embodiment, this microprocessor is also designed to support a JAVA platform of J2ME (Java 2 Micro Edition) type allowing the execution of programs of midlet type (Java applet downloadable to a portable terminal furnished with a J2ME-type platform).

The telecommunication terminal T1 is preferably compatible with the following standards:
MIDP (Mobile Information Device Profile), so as to be able to create an Internet communication channel of “IP socket” (Internet Protocol) type,
WMA (Wireless Message API), so as to be able to start a JAVA application by means of SMS messages.

Preferably, the telecommunication terminal T1 comprises a built-in camera and is compatible with the MMAPI (Mobile Media Application Programming Interface) standard so as to be able to take and record a photo of the user of the terminal, which photo will be incorporated into the data of a profile of this user.

An exemplary implementation of the method according to the invention is now described by reference to FIGS. 2a to 2f.

Represented at one and the same time in these figures are the main exchanges (by arrows representing the voice streams or the data streams) between the terminals T1, T3, the data server PCC and the audioconference bridge MCU as well as the steps implemented in each of these entities.

In the example given in FIGS. 2a to 2f it is assumed that the terminal T1 is a terminal making it possible to establish a circuit mode communication session for receiving and sending voice streams and to simultaneously establish a packet mode communication session for dispatching or receiving data streams. The terminal T3 for its part does not have this possibility. It is thus illustrated that the invention applies to a conference system in which the terminals have various communication capabilities. Specifically, the implementation of the method according to the invention does not assume any prior modification of the terminals, but on the contrary adapts to the types of terminals present. Setting up the information service according to the invention will however be accessible only to terminals capable of simultaneously establishing a communication session for receiving and sending voice streams and a communication session for dispatching or receiving data streams. The presence of other less efficacious terminals does not in any way disturb the implementation of the method according to the invention, the consideration of the type of terminal being managed by the data server PCC.

The first phase of the method, corresponding to the connection of the first participant, is described by reference to FIG. 2a. This first phase begins with step S200 in the course of which a user of the terminal T1 establishes a communication link with the audioconference bridge MCU, by keying into this terminal T1 the telephone number associated with the bridge. This communication link makes it possible to transmit the conference data streams between the terminal and the bridge.

When the communication is set up with the audioconference bridge MCU, the latter detects in step S201 the start of a new conference. It then dispatches to the data server PCC via the IP communication channel D6-D7 data comprising in particular the telephone number Y1 of the calling terminal, an identification X1 of the audioconference as well as a datum coding the nature of the event detected by the audioconference bridge MCU. In this case, the event is the entry to the conference of a first participant. On the basis of the telephone number Y1 transmitted, the data server PCC is able to detect the type of the terminal: a telephone number beginning with the prefix 06 is an indicator of a mobile number. Furthermore, on the basis of the telephone number Y1 transmitted and of the table of subscribers to the audioconference participants information service, the server is able to ascertain the type of terminal used, in particular if the latter is equipped with means allowing it to establish an IP communication channel simultaneously with the channel for transmitting the voice streams. In the exemplary embodiment described here, the data server PCC therefore detects that such means are available to the terminal T1. As a variant, an automatic detection of the type of terminal is obtained by interrogating this terminal.

In step S202, the data server PCC records in the tables of the database 165 the information relating to the opening of a conference. It creates in particular an identifier for the conference in progress and an identifier for the new participant and records the associated data describing this conference and this participant. In the example of FIG. 2a, the terminal which connects first to the audioconference bridge MCU is the terminal T1. The data server PCC dispatches to the terminal T1 a petition in the form of a message of WAP Push type (WAP, Wireless Application Protocol), transmitted by dispatching an SMS of specific format. This message with active content comprises the URL for loading the midlet and makes it possible to trigger, on opening the message, the downloading of a midlet via the WAP navigator of the terminal. A confirmation can be requested of the user before loading. This message is transmitted via the SMS-C center C1 to the terminal T1. Any other message format making it possible to trigger the execution of a program on the recipient terminal is also usable.

On receipt in step S205 of this message, the terminal T1 opens a WAP (Wireless Application Protocol) connection allowing it to access the Internet network via the gateway G1 and to establish in step S210 a communication channel to the data server PCC. In steps S210 and S211, the data server PCC and the terminal T1 dialog for the establishment of this channel. This channel is preferably established in the form of an IP channel by means of an interface of socket type. This type of communication channel, represented schematically by the streams D1 to D4 in FIG. 1, thus allows the establishment of a point-to-point link between the data server PCC and the terminal T1. The format of the data exchanged via this channel is preferably based on the HTTP protocol, but any other format is envisageable. Preferably, the data server PCC signals to the terminal T1 the proper establishment of the channel.

The IP channel created between the terminal T1 and the data server PCC is preferably dedicated and suited to the transmission of control instructions and/or data between the data server PCC and the terminal T1. Preferably, this channel is dedicated to the exchanging of data, information and instructions necessary for setting up the participants information service.

The control instructions, conveyed by this channel originating from the data server PCC destined for the terminal T1, are for example:
a request to record a suite of information in the terminal T1; for example a request to record one or more profiles, the server dispatching an identifier of the profile and the data associated with this profile;
a request to display information; for example a request to display one or more profiles, the server dispatching the identifiers of the profile and the data associated with these profiles.

As a variant, when the information to be displayed has been recorded beforehand in the terminal T1 in association with an identifier, the server dispatches in the guise of display request only an identifier of the suite of information to be displayed. This allows a significant gain in terms of processing lag and amount of data to be transmitted. For example, only an identifier of the profiles to be displayed or a simple participant identifier is dispatched to the terminal to cause the display of the profile associated with this or these identifiers. This variant can be proposed to the user by the midlet in the form of an option or be imposed by the data server.

According to another variant, the display control instruction is accompanied by a text descriptive of the event associated with the display, of the type “X has rejoined the conference”, “X has left the conference”, “X is speaking”, etc., where X is the name of the participant whose identifier has been transmitted.

The control instructions, conveyed by the IP channel originating from the terminal T1 destined for the data server PCC, are for example:
a request to create a profile, the terminal dispatching the data associated with the profile, the server sending back in return the identifier of the profile created;
a request to delete a profile, the terminal dispatching the identifier of the relevant profile;
a request to modify a profile, from among a list of given profiles, the terminal dispatching the identifier of the relevant profile, and the new data to be associated with the modified profile, which replaces the data previously recorded;
a request to select a profile so as to participate in the conference, from among a list of given profiles, the terminal dispatching the identifier of the relevant profile;
a request to select a given format from among a set of possible formats for dispatching information about events.

The exchange of data between the terminal T1 and the data server PCC can also include acknowledgments of receipt of instructions, data or petitions dedicated to the maintenance of the communication channel, dedicated for example to verifying the identity of the terminal, synchronizing the messages, signaling errors, initializing or ending the communication, etc. All these data and information are necessary for implementing the participants information service.

Returning to FIG. 2a, when the IP channel has been established, the data server PCC updates the table of subscribers in the database 165. In the event of failure to establish the connection, a code indicative of this failure is recorded in the subscriber data. In the event of success another code is recorded by the data server PCC. The success or failure codes recorded allow the data server PCC to know in particular whether the terminal T1 of the relevant subscriber has already downloaded the midlet. Specifically, if in step S202 the data server PCC were to notice on the basis of the data that it has recorded that the terminal T1 has already downloaded the midlet, it is envisaged that the SMS dispatched by the data server PCC should trigger on its receipt by the terminal T1, not the downloading of the midlet, but simply the running of the midlet. In this case, step S216 is not executed by the terminal T1 and the latter goes directly from step S210 to step S217.

In step S216, the midlet is loaded from the data server PCC via the IP channel created, then installed in the terminal T1. The midlet is preferably customized so as to contain the information regarding the telephone number of the terminal T1 to allow identification of this terminal. The midlet is thereafter started in step S217. Preferably the midlet is designed to start automatically without requiring any intervention by the user of the terminal T1.

The installation of the midlet, its starting and the establishment of the data transmission channel are therefore entirely automated and can if appropriate be rendered entirely transparent to the user of the terminal. The latter does not therefore have any manipulation to do apart from a possible initial parameterization of the service and the creation of profiles corresponding to the data that he wishes to see transmitted to the other participants during the conference. Configuration of the terminal is therefore entirely automatic.

The second phase of the method, corresponding to a profile creation, is described in FIG. 2b. When the communication channel is established, the method continues in step S225 with a profile creation request which is dispatched via the communication channel D1-D4 of the terminal T1 to the data server PCC. In this profile creation request, the user dispatches the data associated with the profile: name, forename, information, photograph, etc. Following the receipt in step S226 of the profile creation request, the data server PCC creates a new profile, records the data of the profile in the table of profiles and assigns the profile an identifier. Then, in step S227, it dispatches the identifier of the profile to the terminal T1, and simultaneously a display instruction.

Following the receipt in step S228 of the identifier, the terminal T1 records the identifier of the profile so as to be able to retrieve the associated data on the basis of this profile identifier alone. This is done for example by means of a profile table similar to that maintained by the data server PCC in the database 165.

The display instruction received in step S228 is processed by the midlet which will control in step S229 the display of the terminal as a function of the parameters of this instruction. Display consists in this situation in displaying the data of the profile on the terminal T1, preferably with the photograph of the participant. As a variant a message can be displayed simultaneously with the data of the profile so as to signal that the person whose profile has just been displayed has rejoined the audioconference.

As a variant, steps S225 to S229 are executed during the conduct of the conference, for example on the initiative of the user of the terminal T1. To do this, the latter selects an option in a menu proposed by the midlet undergoing execution.

According to another variant the profile creation of steps S225 to S229 can be performed off-line, for example when a user registers with the participant information service, for example via a Web portal serving for registration and administration of the service. In all the variants, the various profiles created by a user are recorded by the data server PCC in the database 165.

The third phase of the method, corresponding to the arrival of a new participant, is described by reference to FIG. 2c. In step S230, the user of the fixed terminal T3 keys in the number of the audioconference bridge. The audioconference bridge MCU, receiving this call, detects in step S231 the connection of a new participant and dispatches to the data server PCC via the IP communication channel D6, D7 data comprising in particular the telephone number Y3 of the calling terminal, an identification X1 of the audioconference as well as a datum coding the nature of the event detected by the audioconference bridge MCU, the event here being the arrival of a new participant in a conference in progress.

The data server PCC analyzes in step S232 the data received and records a participant profile identifier for the audioconference X1. On the basis of the telephone number Y3 transmitted and of the associated subscriber data, the data server PCC is able to detect that the terminal associated with the number Y3 is a terminal that does not possess the means for establishing an IP communication channel with the data server PCC.

The data server PCC manages in fact two categories of terminals:
category A terminals, making it possible to establish a data transmission channel which is independent of the voice stream transmission channel and which allows the receipt by the terminal considered of a data stream simultaneously with the voice stream received,
category B terminals which do not allow it.

This independence manifests itself in particular by the fact that the trunking mode for the data stream for informing the participants traveling through the IP channel is independent of the trunking mode for the voice streams. It follows from this that there is no constraint—for example no constraint of time synchronization type—between these two sorts of stream. This independence manifests itself also by the fact that these two sorts of stream can use a different type of link, a different network or type of network. For example, when the terminal T1 establishes a circuit mode communication link for the transmission of voice streams, the IP channel between the terminal T1 and the data server PCC may itself be created by a packet mode link. The processing performed by a terminal on the voice streams that it receives is also independent of the processing performed by this same terminal on the information data streams that it receives.

A sort of coordination, between on the one hand the content of the voice streams received by the conference server and on the other hand the content of the information streams provided to the terminals, is carried out by virtue of the data server PCC on the basis of detected events, signaled by the audioconference bridge MCU. This coordination is afforded by implementing the steps consisting in determining events that are predefined on the basis of the conference data streams, then in generating, for each event determined, information about this event, this information thereafter being dispatched by the data server to the terminals that have established a data transmission link.

Other terminals, for example T2 or T4, T5 can connect to the conference in the same manner as the terminal T3. Terminal T2 is here in category B like terminal T3 while terminals T4 and T5 are in category A like terminal T1, with the difference however that the voice streams associated with terminal T4 are transmitted in packet mode (in VoIP mode) while for terminal T1 or T5, they are transmitted in circuit mode. For terminals T1, T4 and T5, the data transmission channel is for its part established each time in packet mode.

The rest of the description is limited for the sake of simplification to an audioconference between a category A terminal T1 and a category B terminal T3. The invention is however applicable to an arbitrary number of terminals, regardless of the category of these terminals. Of course, only the category A terminals will have access to the participants information service according to the invention. Moreover the invention automatically adapts to the types of terminals participating in the audioconference without penalizing the most efficacious terminals.

Returning to FIG. 2c, the data server PCC generates in step S233 a control instruction intended for the terminal T1. This control instruction comprises the data of the profile of the participant Y3, an associated profile identifier, and a display request instruction. The profile is here a default profile, created off-line, and comprises for example only a name and forename. This instruction is transmitted via the IP communication channel D1-D4 to the terminal T1. On receipt of this instruction, the midlet of the terminal T1 records in step S234 the data of the profile, then controls the display of the data of the profile in step S235.

During display of this profile, a message can be displayed simultaneously with the data of the profile so as to signal that the person whose profile has just been displayed has rejoined the audioconference. In this variant embodiment, when several participants have rejoined the audioconference, if the number of participants and the resolution of the screen so allow, it is possible to display all the profiles of the participants of the audioconference simultaneously and to signal by color, setting in relief, blinking, etc., the profile relevant to the message which is displayed.

The fourth phase of the method, corresponding to the conduct of the audioconference, is described by reference to FIG. 2d. During the audioconference, the audioconference bridge MCU is able to detect the voice activity of the conference on the basis of voice streams that it receives. Thus the voice streams sent by the speaker Y1 from the terminal T1 (step S240A) and the speaker Y3 from the terminal T3 (step S240B) are dispatched to the audioconference bridge MCU. In step S241, the audioconference bridge MCU mixes the stream or streams that it receives, so as to retransmit them to the other terminals.

The bridge furthermore proceeds to the determination of the voice conference activity. It proceeds in particular to the detection of the active speaker on the basis of the voice streams received, the participant identified as being the active speaker being the presumed user of the terminal for which the voice stream sent exhibits the highest sound level. When a new active speaker (who in the example of FIG. 2d is the user Y1 of the terminal T1) is detected, the audioconference bridge MCU dispatches event identification data to the data server PCC to signal this change of speaker or this new speaker. These event identification data comprise in particular an identifier X1 of the current audioconference and of the terminal Y1 from which the stream identified as being that of the active speaker originates. On receipt in step S242 of these event identification data, the data server PCC dispatches, to all the subscribers to the information service that have established an IP communication channel (to the category A terminals), event information comprising for example the identifier of the profile of the active speaker. This event information is preferably dispatched in control instruction form.

On receipt in step S243 of this control instruction, the midlet of the terminal T1 displays the profile corresponding to the identifier received, and optionally, an associated message indicating that the relevant participant is speaking. The same holds for the other category A terminals possibly participating in the conference.

During the audioconference, steps S240 to S243 are repeated in a cyclic manner, the audioconference bridge MCU detecting the events related to the conduct of the audioconference (entry of a participant to the conference, exit of a participant from the conference, identification of a participant as new active speaker, a participant speaking, a participant asking to speak, etc.) and generating event identification data, the data server PCC processing these event identification data so as to generate information about the detected events and to dispatch the latter, for example in control instruction form, to the terminals that have established an IP communication channel, the terminals retrieving information intended to be displayed on the basis of the information transmitted by the server PCC.

On the basis of the data identifying the terminal involved in the event and on the basis of the data tables available to it, the data server PCC is able to retrieve information about the identity of the presumed user of the terminal or terminals from which the detected event originates, and therefore to transmit information about the events comprising information about the participant or participants relevant to the detected event.

Generally, the data server PCC dispatches to the terminal T1, for each event detected and signaled by the audioconference bridge MCU, information characteristic of the detected event, for example the identifier of the participant relevant to the event, the identifier of the profile of the participant relevant to the event, a message descriptive of the event, data describing the event, etc.

The information displayed following the receipt of this information is either included in the information transmitted (case where the profile is transmitted in the data), or retrieved by means of the information transmitted (for example in the form of identifiers) on the basis of information prerecorded on the terminal. In this second option, the amount of information transmitted is thus very small, thereby making it possible to reduce to the minimum the duration of the data exchanges and processing necessary to bring about the display of the information. Display therefore tracks the events (someone taking a turn to speak, etc.) in quasi-real time.

As a variant of signaling by display, it is possible to provide signaling by sending a sound or voice signal, by triggering a vibration, by message dispatch, etc. Any other appropriate form of signaling is envisageable.

The information relating to the detected event is thus made available to the user of the terminal by display or by any other means. This makes it possible to inform the user about events that he is not able to readily detect by himself or that he is not able to detect in an unambiguous manner.

As a variant, instead of signaling each time someone takes a turn to speak, a given turn to speak is signaled only if it has a minimum duration. A minimum timeout duration, corresponding to the minimum duration of speaking below which a turn to speak is not signaled to the terminals, is thus defined. This duration is for example between 1 and 3 seconds. It must be small enough not to cause too significant a time offset between the speaking of a participant and the moment at which a terminal actually displays the information associated with this turn to speak. It must be high enough to avoid display control instructions that are too close together and therefore an instability of the display of the terminal and discomfort for the participants.

The fifth phase of the method, corresponding to the departure of a participant, is described by reference to FIG. 2e. When in step S250 a participant (here the user of the terminal T3) leaves the audioconference by closing the communication link, the audioconference bridge MCU detects it in step S251 and dispatches to the data server PCC via the IP communication channel D6, D7 data comprising in particular the telephone number Y3 of the terminal leaving the conference, an identification X1 of the audioconference as well as a datum coding the nature of the event detected by the audioconference bridge MCU, here the departure of a participant.

On receipt in step S252 of the data, the data server PCC records the information in the database by deleting the profile of the participant, then dispatches to the category A terminals which are still in a communication link with the bridge a control instruction comprising the identifier of the profile of the participant who has left the conference as well as an associated instruction code.

On receipt in step S255 of this instruction, the midlet of the terminal T1 processes this instruction and controls the display means 100, ordering it to signal the departure of the participant from the terminal T1. This signaling consists for example in making the profile of the participant blink on the terminal and in simultaneously displaying a message indicating the departure of the associated participant.

The sixth phase of the method, corresponding to the end of the conference, is described by reference to FIG. 2f. When in step S260 the last participant (here the user of the terminal T1) leaves the audioconference, the audioconference bridge MCU detects it in step S261 and dispatch data server PCC via the IP communication channel D6, D7 data comprising in particular an identification X1 of the audioconference as well as a datum coding the nature of the event detected by the audioconference bridge MCU, here the departure of the last participant.

On receipt in step S262 of the data, the data server PCC records the information in the database by deleting the profile of the participant.

In step S265, the last participant having left the conference, the data server PCC closes the communication channel established with the terminal T1. In step S266, the terminal T1 also closes the channel on its side and the midlet of the terminal T1 terminates.

The scenario which has just been described by reference to FIGS. 2a to 2f corresponds to a simplified example where two terminals T1 and T3 are in an audioconference. It is generalizable to any number of terminals. Each of the terminals is either in the case of the terminal T1, or in the case of the terminal T3 depending on whether or not it is possible for this terminal to establish a data transmission channel independent of the voice stream transmission channel for the terminal. For each terminal for which this is possible, the data server PCC establishes a data transmission link, in the form for example of an IP communication channel, for transmitting the display control instructions. For the other terminals, the conference is conducted in a transparent manner, without however allowing their user access to the dynamic information service according to the invention. The audioconference bridge MCU for its part detects, whichever terminals are present, the events associated with the audioconference (arrival or departure of a participant, new active speaker) and transmits the data identifying these events to the data server PCC which processes them so as to dispatch the information about these events to the relevant terminals.

The exemplary embodiments described relate in particular to the implementation of an information service regarding the speaking of the participants of an audioconference. The invention however generalizes to the implementation of an information service regarding the conduct of a telephone conference, in particular information about any event detectable by the conference server: duration of speaking of each participant, sound volume detected, duration of connection of each participant, etc. In the general context of implementation of the invention, the nature of the events detected and of the information capable of being transmitted to the participants of a telephone conference by setting up a transmission channel dedicated to the information service is not restricted. Such a channel can be usefully used for the real-time transmission of any type of information.

Variant embodiments are possible relating to the protocol for data exchange between the data server PCC and the terminal T1 or between the data server PCC and the audioconference bridge MCU. In particular, additional messages can be provided so as to guarantee the reliability or security of the data exchanges thus carried out.

As a variant of the system represented in FIG. 1, the data server PCC and the audioconference bridge MCU can be embodied in the form of a single data processing device integrating the means and functionalities of the server and bridge. This does away with the requirement to establish the communication channel D6-D7. The solution presented in FIG. 1 has however the advantage of being able to be easily set up on current audioconference systems, by adding a data server PCC and setting up the communication interfaces between the data server PCC and the audioconference bridge MCU.

The system which has been presented makes it possible to set up a generic solution for synchronization between the content of two independent streams, one of which is transmitted in circuit mode and the other in packet mode. This principle is used in the context of the implementation of a speaker information service during an audioconference, in which the voice streams received at the bridge level are used to generate one or more data streams transmitted independently of the voice streams.

The principle is moreover also applicable to the case where a terminal (for example terminal T4, of personal computer type) were to access the audioconference via the VoIP technique, by setting up an IP communication channel dedicated to the transmission of display control instructions which would be independent of the IP transmission channels of the conference data streams. In this case these streams comprise at one and the same time voice streams (for example via RTP) and data streams for controlling the voice streams (for example via RTCP). For such a terminal, the establishment of the communication channel will preferably be triggered manually by the user, for example by manually running a suitable program, the triggering by SMS of a program generally not working for this type of terminal, for reasons of security of access to this terminal.

The principle is moreover adaptable to group telephone conversation systems of Push To Talk type. In these systems, detection of the active speaker can be carried out either on the basis of the requests to speak sent by the terminals via a conference data stream, or directly on the basis of the conference voice streams received by the telephone connection server.

The operating principle of the invention is therefore applicable to any group telephone conversation system considered, regardless of the type of terminal present, regardless of the networks for trunking the voice streams. It the setting up of a single type of data server, regardless of the conference servers that exist.

1. A method for supplying information to the participants in a telephone conference about a conduct of said telephone conference, said telephone conference being implemented by a plurality of terminals accessing a telecommunication network, a communication link being established between each terminal and a conference server for the transmission of at least one conference data stream, the method comprising the following steps:
a data transmission link is established between at least one of the terminals and a data server accessing said telecommunication network, said data transmission link being independent of the communication link established for the terminal considered;
the conference server analyzes the conference data streams received from the terminals in the course of the conference, determines at least one predefined event relating to the conduct of the conference, generates event identification data for each event determined, and transfers said identification data to the data server;
the data server analyzes said event identification data, generates event information relating to the identified events, and transmits said event information, via at least one said data transmission link, destined for said at least one of said terminals for which a data transmission link has been established.

2. The method as claimed in claim 1, wherein, for a given terminal, said data transmission link is established following the detection by the conference server of the establishment of the communication link with the terminal considered.

3. The method as claimed in claim 1, wherein said data transmission link established for a given terminal is suited to the receipt by the terminal considered of a data stream simultaneously with the receipt of said at least one conference data stream.

4. The method as claimed in claim 1, wherein each recipient terminal of said event information processes this information so as to generate and display on a screen fitted to said terminal information relating to the event considered.

5. The method as claimed in claim 4, wherein the information displayed on the screen of each recipient terminal comprises information about the identity of the presumed user or users of the terminal or terminals involved in said event considered.

6. The method as claimed in claim 1, wherein said at least one predefined event belongs to a group of events comprising: “a participant enters the conference”, “a participant exits the conference”, “identification of a participant as new active speaker”, “a participant's turn to speak”, “and a participant asks to speak”.

7. The method as claimed in claim 6, wherein the identification of a participant as new active speaker is obtained by voice activity analysis of the voice streams included in the conference data streams, the participant identified as being the active speaker being the presumed user of the terminal whose voice stream exhibits the highest sound level.

8. The method as claimed in claim 1, wherein, for at least one of the terminals for which a data transmission link is established, this data transmission link is established in packet mode, while the communication link is established in circuit mode.

9. The method as claimed in claim 1, wherein said data server is a specific module included in said conference server.

10. The method as claimed in claim 1, wherein said data server dispatches a message destined for at least one of said terminals for which a data transmission link has been established so as to trigger the establishment of the data transmission link for the terminal considered and the transmission in the course of the conference of said event information via said established data transmission link.

11. The method as claimed in claim 1, wherein when a terminal considered from among said plurality of terminals is a mobile telephone terminal, the data server dispatches to said mobile telephone terminal considered, following the establishment for this terminal of said communication link, a message of short message type so as to trigger the establishment of said data transmission link for said terminal considered as well as the running in said terminal considered of a piece of software for executing the following steps:
receiving said event information via said data transmission link,
processing said event information received so as to generate information to be displayed, and
controlling the display by a screen fitted to the terminal considered of said information to be displayed.

12. A data server used for the implementation of a method according to claim 1, said server comprising:
means for establishing a data transmission link with at least one of the terminals, said data transmission link being independent of the communication link established for the terminal considered;
means for receiving from said conference server event identification data relating to the conduct of the conference;
means for analyzing said event identification data and generating event information relating to the identified events; and
means for transmitting said event information, via at least one said data transmission link, destined for at least one of said terminals for which a data transmission link has been established.

13. The data server as claimed in claim 12, wherein said data server comprises means for dispatching a message destined for at least one of said terminals for which a data transmission link has been established so as to trigger the establishment of the data transmission link for the terminal considered and the transmission in the course of the conference of said event information via said established data transmission link.

14. A conference server used for the implementation of a method as claimed in claim 1, comprising:
means for analyzing the conference data streams received from the terminals in the course of the conference, and determining at least one predefined event relating to the conduct of the conference;
means for generating event identification data for each event determined; and
means for transferring said identification data to said data server.

15. A conference server including a data server as claimed in claim 12.
